(19) United States
(12) Patent Application Publication
(10) Pub. No.: US 2009/0042576 A1
(43) Pub. Date: Feb. 12, 2009

(54) METHOD AND APPARATUS FOR HANDLING MOBILITY BETWEEN NON-3GPP TO 3GPP NETWORKS

(75) Inventors: Rajat P. Mukherjee, Stanford, CA (US); Mohammed Sammour, Montreal (CA); Shankar Somasundaram, Deer Park, NY (US); Diana Pani, Montreal (CA)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/180,288

(22) Filed: Jul. 25, 2008

Related U.S. Application Data
(60) Provisional application No. 60/952,472, filed on Jul. 27, 2007.

(51) Int. Cl. H04W 36/00; H04M 1/00

(52) U.S. Cl. 455/436; 455/552.1

(57) ABSTRACT

A method and apparatus for handling mobility between a non-third generation partnership project (3GPP) radio access technology (RAT) and a 3GPP RAT includes utilizing services provided by the non-3GPP RAT. A need to utilize services provided by the 3GPP RAT is determined and a 3GPP non-access stratum (NAS) state is entered. 3GPP messages are tunneled to the 3GPP EPC network over the non-3GPP access RAT and a transition is made from the non-3GPP RAT to the 3GPP RAT. A 3GPP NAS state transition is made and a transition to a second 3GPP NAS state occurs.

### CROSS REFERENCE TO RELATED APPLICATIONS

This application claims the benefit of U.S. provisional application No. 60/952,472, filed Jul. 27, 2007, which is incorporated by reference as if fully set forth.

### FIELD OF INVENTION

This application is related to wireless communications.

### BACKGROUND

Current efforts for the Third Generation Partnership Project (3GPP) Long Term Evolution (LTE) program is to develop new technology and new architectures for new methods and configurations in order to provide improved spectral efficiency, reduced latency and better utilization of radio resources for faster user experiences and richer applications and services with less cost. As part of this evolution, 3GPP is considering the support of handover to non-3GPP Radio Access Technologies (RATs), such as WiMAX and technologies developed by 3GPP2, such as CDMA2000, for example, with a minimum delay.

FIG. 1 is a functional block diagram 100 of a conventional handover preparation from a non-3GPP access network to an evolved universal terrestrial radio access network (E-UTRAN) connected to an Evolved Packet Core (EPC) network. As shown in FIG. 1, LTE non-access stratum (NAS) signaling over layer-2 (L2) non-3GPP access is depicted.

FIG. 2 is a functional block diagram 200 of a conventional handover preparation from an E-UTRAN network connected to the EPC to a non-3GPP access network. As shown in FIG. 2, LTE NAS signaling is depicted over a non-3PPP access layer 2 signaling.

FIG. 3 shows a conventional E-UTRAN NAS and radio resource controller (RRC) state machine 300. The signaling depicted in FIGS. 1 and 2 may pose a problem to the state machine 300. FIG. 3 depicts three states—LTE_DETACHED, LTE_IDLE and LTE_ACTIVE. These states represent at a high-level the status of the registration of a wireless transmit/receive unit (WTRU) and the availability of a signaling connection for the WTRU to use. These states may map to more detailed RRC and NAS Evolved Packet System Mobility Management (EMM) states. Traditionally, the NAS may perform attach/authentication procedures only after it has successfully performed Public Land Mobile Number (PLMN) and cell selection and is camped on a cell in the LTE_DETACHED state. However, if a WTRU is operating under the single-radio assumption, (i.e., the WTRU transmits and receives using only one radio access technology (RAT) at a time), then it is not certain whether the 3GPP stack in the WTRU will be in a state to perform an attach procedure, authentication or service request.

The packet data protocol (PDP) Context or Internet protocol (IP) addresses and their associated evolved packet system (EPS) bearer parameters, (e.g., uplink/downlink (UL/DL) traffic flow template (TFT), radio bearer mappings, and the like), may need to be configured in the WTRU and the target evolved Node B (eNB) to allow for fast handover upon transition to the target. The IP address along with the bearer parameters and associated UL and DL TFTs represent an EPS bearer context. Accordingly, it would be beneficial to provide a method and apparatus for handling mobility between 3GPP and non-3GPP networks.

### SUMMARY

A method and apparatus for handling mobility between a non-third generation partnership project (3GPP) radio access technology (RAT) and a 3GPP RAT is disclosed. The method includes utilizing services provided by the non-3GPP RAT. A need to utilize services provided by the 3GPP RAT is determined and a 3GPP non-access stratum (NAS) state is entered. 3GPP messages are tunneled to the 3GPP EPC network over the non-3GPP access RAT and a transition is made from the non-3GPP RAT to the 3GPP RAT. A 3GPP NAS state transition is made and a transition to a second 3GPP NAS state occurs.

### BRIEF DESCRIPTION OF THE DRAWINGS

A more detailed understanding may be had from the following description, given by way of example in conjunction with the accompanying drawings wherein:

FIG. 1 is a functional block diagram of a conventional handover preparation from a non-3GPP access network to an E-UTRAN;

FIG. 2 is a functional block diagram of a conventional handover preparation from an E-UTRAN to a non-3GPP access network;

FIG. 3 shows a conventional E-UTRAN NAS and RRC state machine;

FIG. 4 shows an example wireless communication system including a plurality of WTRUs and an eNB;

FIG. 5 is an example functional block diagram of a WTRU and eNB of FIG. 4;

FIG. 6 shows an example 3GPP NAS state machine;

FIG. 7 is a flow diagram of a method of handling tracking area updates;

FIG. 8 is a flow diagram of a method of handling EPS bearer context transfers; and

FIGS. 9A-9B are an example signal diagram for a non-3GPP to 3GPP handover.

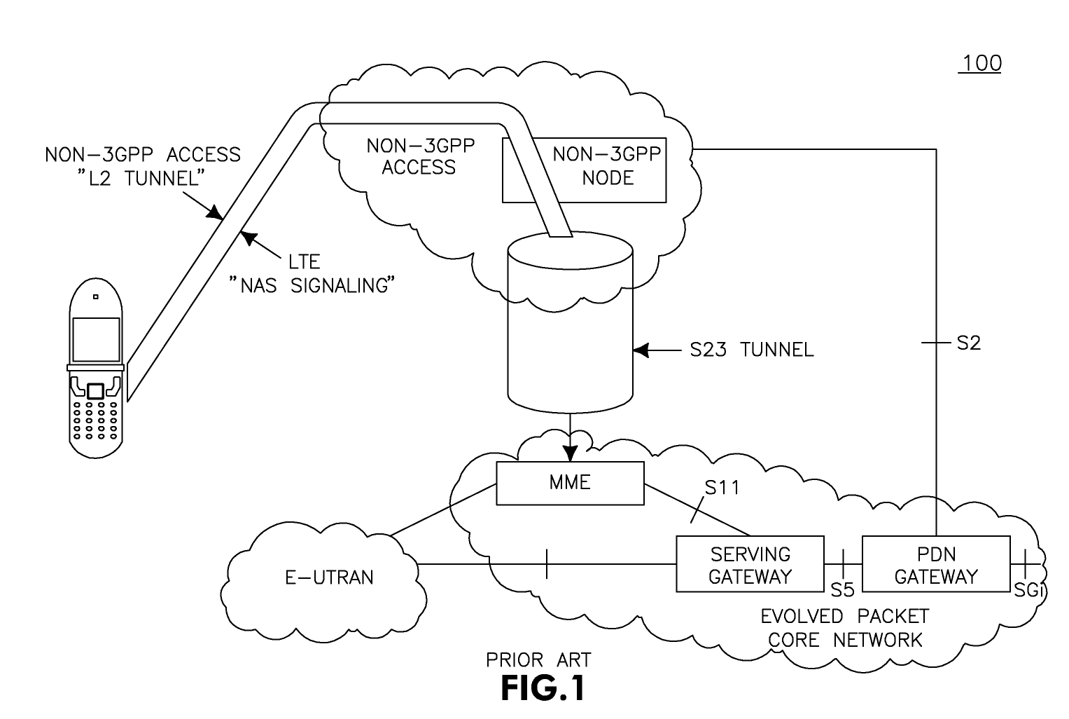

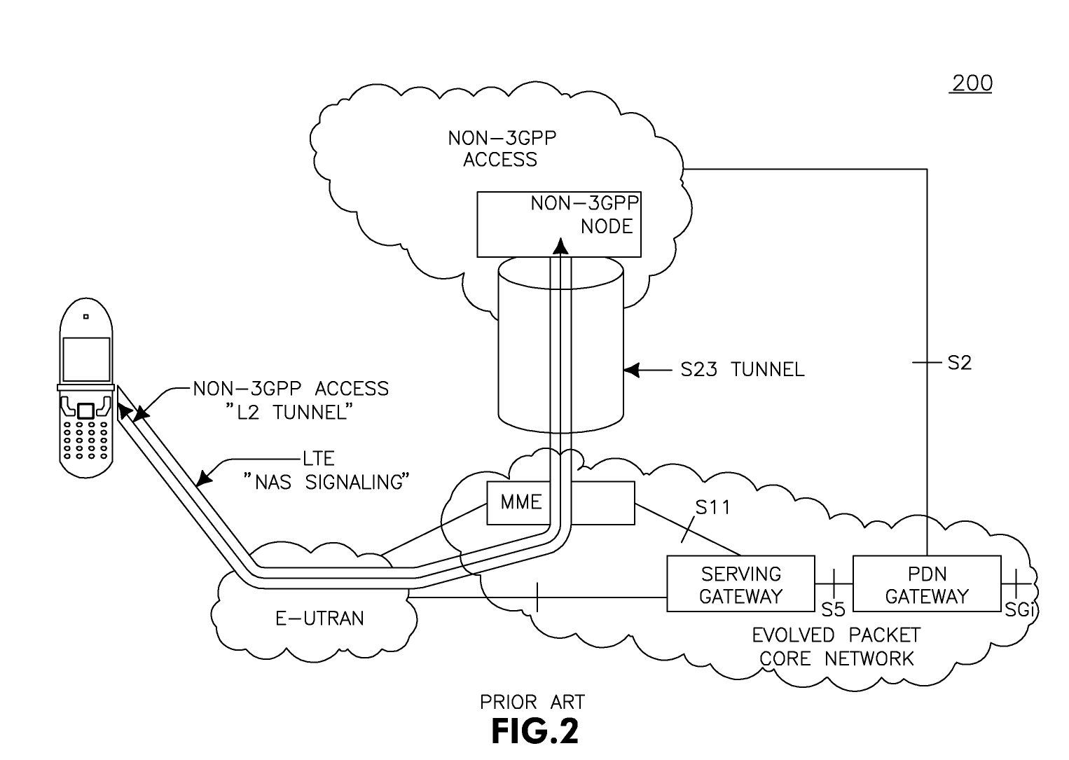

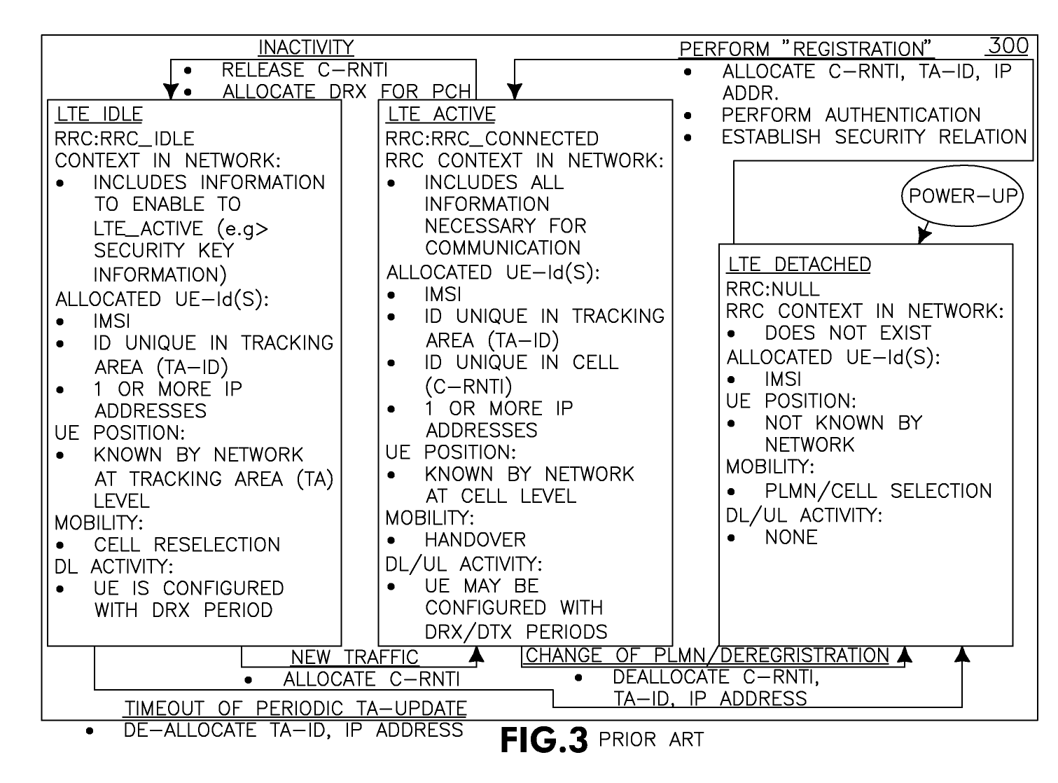

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

Hereinafter, Third Generation Partnership Project (3GPP) may collectively refer to Long Term Evolution (LTE), Wideband Code Divisional Multiple Access (WCDMA), Global System for Mobile telecommunications (GSM) and related technologies, such as high speed packet access (HSPA). For example, references to LTE_Idle, LTE_Active, and tracking areas may be extended to equivalents in other technologies, such as PMM_Idle, PMM_Connected, and routing areas.

Additionally, the phrase ‘tunnel’ as used hereinafter refers to any method that allows 3GPP messages to be sent over a non-3GPP network to the 3GPP stack in the WTRU 410. This may not take the form of an explicit “tunnel” but may be some other mechanism. Similarly, “tunnel establishment” refers to setting up the above mechanism, and it may not be necessary or may be pre-existing.

The methods and apparatus described herein are applicable to handover between 3GPP and non-3GPP radio access technology (RAT).

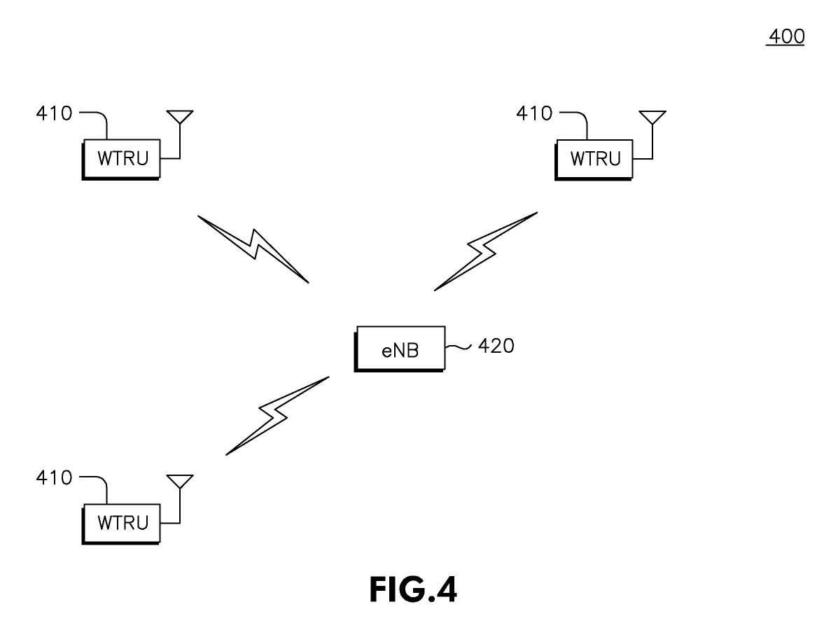

FIG. 4 shows an example wireless communication system 400 including a plurality of WTRUs 410 and an eNB 420. As shown in FIG. 4, the WTRUs 410 are in communication with the eNB 420. It should be noted that, although an example configuration of WTRUs 410, and an eNB 420 is depicted in FIG. 4, any combination of wireless and wired devices may be included in the wireless communication system 400.

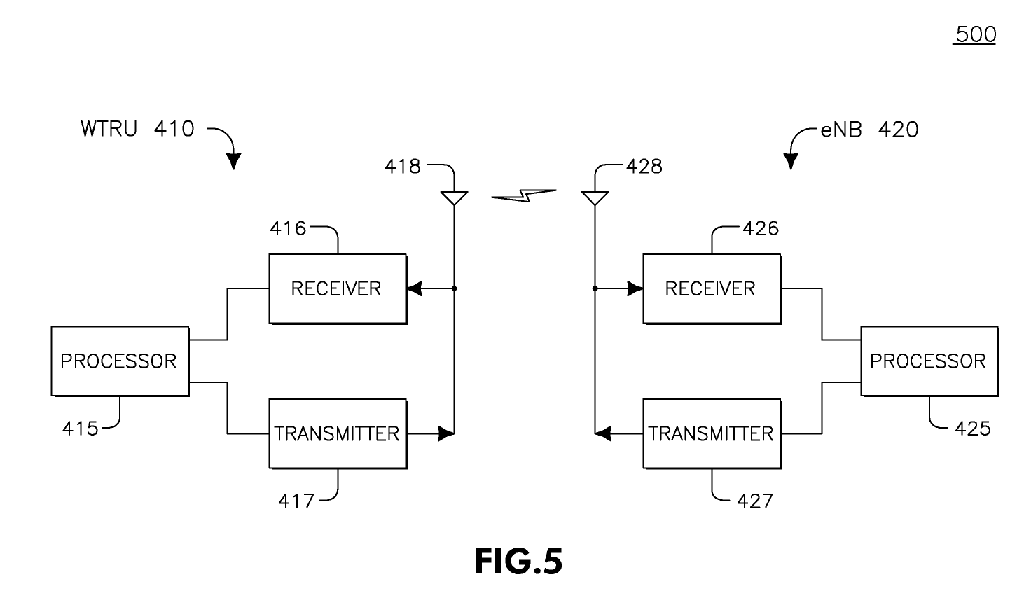

FIG. 5 is an example functional block diagram 500 of a WTRU 410 and the eNB 420 of the wireless communication system 400 of FIG. 4. As shown in FIG. 5, the WTRU 410 is in communication with the eNB 420.

In addition to the components that may be found in a typical WTRU, the WTRU 410 includes a processor 415, a receiver 416, a transmitter 417, and an antenna 418. The receiver 416 and the transmitter 417 are in communication with the processor 415. The antenna 418 is in communication with both the receiver 416 and the transmitter 417 to facilitate the transmission and reception of wireless data. The processor 415 of the WTRU 410 is configured to handle mobility between non-3GPP to 3GPP networks.

In addition to the components that may be found in a typical eNB, the eNB 420 includes a processor 425, a receiver 426, a transmitter 427, and an antenna 428. The receiver 426 and the transmitter 427 are in communication with the processor 425. The antenna 428 is in communication with both the receiver 426 and the transmitter 427 to facilitate the transmission and reception of wireless data. The processor 425 of the eNB 420 is configured to handle mobility between non-3GPP to 3GPP networks.

WTRU procedures, and associated state machines, such as non-access stratum (NAS) mobility management/session management (MM/SM) and radio resource control (RRC), for example, may enable the 3GPP stack in the WTRU to perform signaling, such as NAS/RRC, for example, over a non-3GPP tunnel, despite not having performed procedures such as obtaining a RRC connection or performing formal public land mobile network (PLMN)/Cell-selection.

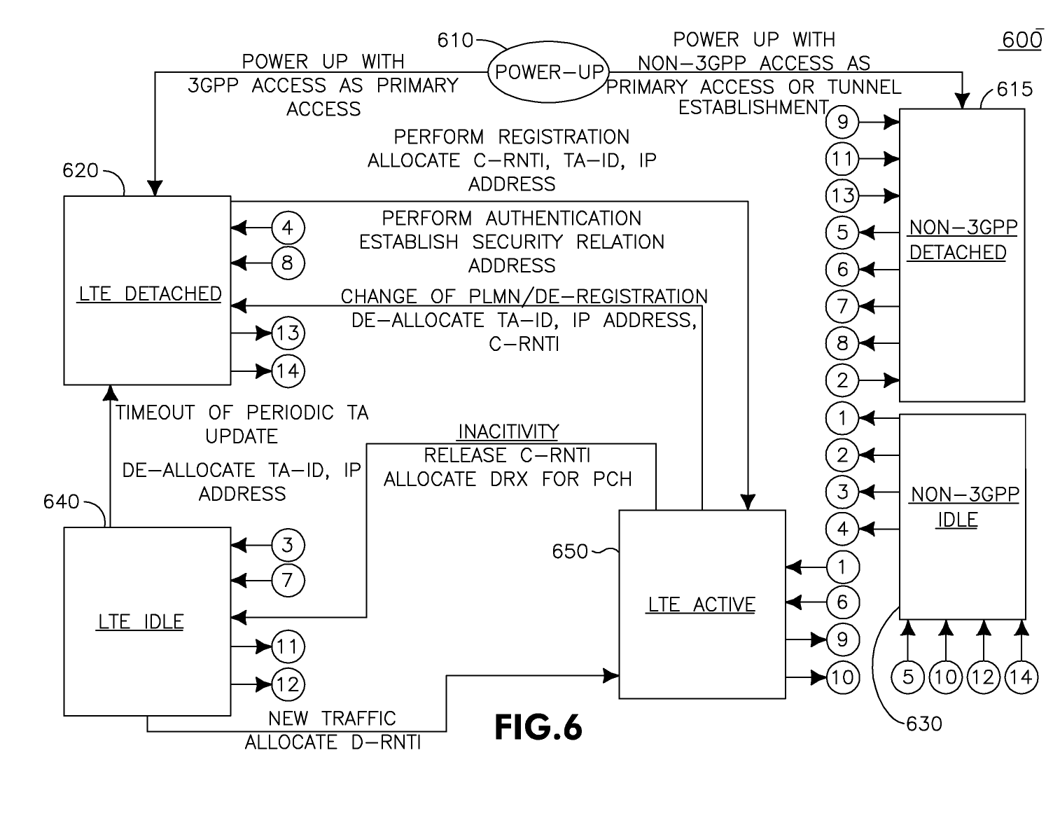

FIG. 6 shows an example 3GPP NAS state machine 600. The state machine 600 includes a power up state 610, a Non-3GPP_DETACHED state 615, an LTE_DETACHED state 620, a Non-3GPP_IDLE state 630, and LTE_IDLE state 640, and an LTE_ACTIVE state 650. The LTE_DETACHED state 620, the LTE_IDLE state 640 and the LTE_ACTIVE state 650 represent the status of the WTRU context and a signaling connection with the network. In addition, the Non-3GPP_DETACHED state 615 and Non-3GPP_IDLE state 630 may be introduced into a detailed EPC NAS state machine such as an EMM state machine. In the power up state 610, the WTRU 410 may power up with non-3GPP access as its primary access or use tunnel establishment over 3GPP access. In this case, the WTRU 410 enters the Non-3GPP_DETACHED state 615. The WTRU 410 could also power up with 3GPP access as its primary access. In this case, the WTRU 410 may enter the LTE_DETACHED state 620.

In the 3GPP NAS Non-3GPP_DETACHED state 615, certain WTRU behavior may be defined. For example, the RRC layer may be in any defined RRC state. Specifically the RRC layer may be in RRC_NULL_NON-3GPP or Idle_Non-3GPP. An allocated WTRU ID is the international mobile subscriber identity (IMSI) and the WTRU's position may not be known by the 3GPP network. There is no RRC context in the 3GPP network nor is there any DL or UL activity over any 3GPP access. In this state the WTRU 410 is not registered with the 3GPP network and uses its non-3GPP access to communicate with the non-3GPP network using procedures specific to the type of non-3GPP access. WTRU Mobility may be restricted to at least one of public land mobile network (PLMN) selection, cell selection, modified cell or PLMN selection, or no WTRU based mobility at all.

In the LTE_DETACHED state 620, there is no signaling connection with the network and the RRC layer is not monitoring paging channels, nor is it camped on a cell. In addition, there may not be an RRC context in the network or any DL or UL activity over the LTE access. The WTRU ID is the IMSI. WTRU Mobility is restricted to PLMN and/or cell selection. There is no WTRU context in the EPC network. The NAS EMM (EPS Mobility Management) layer is in EMM-DEREGISTERED or EMM-NULL or EMM-REGISTERED-INITIATED state) and there is no signaling connection established either (i.e. WTRU is in EMM-IDLE mode).

In the 3GPP NAS Non-3GPP_IDLE state 630, the NAS layer, (e.g. the EMM layer), in the WTRU 410 is registered with the 3GPP network, (e.g., using a non-3GPP L2 access tunnel or upon handover from 3GPP to non-3GPP without detaching from the network), but utilizes non-3GPP layer 2 access. The 3GPP LTE RRC layer may not be camped on a 3GPP LTE cell and may not be searching for other 3GPP cells. In addition, the 3GPP LTE RRC layer may be in an RRC_NULL_NON-3GPP state, an Idle_Non-3GPP state, or in some other RRC state, (e.g. NULL). The WTRU 410 context in the EPC network may include information to enable fast transition to the LTE_ACTIVE state 650. For example, the context information may include security key information. Allocated WTRU IDs may include the IMSI and a Globally Unique Temporary Identity (GUTI). The WTRU 410 may have been allocated at least one unique tracking area (TA) ID and one or more IP addresses. The WTRU's position may be known by the network at the TA level. WTRU Mobility may include handover or cell reselection or modified cell reselection between non-3GPP and 3GPP technology and DL/UL activity may include the WTRU 410 being configured with a discontinuous reception (DRX) period. Alternatively, there may be no WTRU mobility in this state as defined by 3GPP procedures. The WTRU 410 may choose not to perform cell selection and/or re-selection and/or PLMN selection, or may perform modified versions of these procedures, (e.g. with low frequency).

In the LTE_IDLE state 640, the RRC layer is in RRC_IDLE. In this state, the WTRU 410 has registered with the network but there is no signaling connection established with the network. The NAS EMM layer may be in any state corresponding to the existence of an established context, (e.g., EMM-REGISTERED state), but as there may be no signaling connection, the WTRU 410 is in EMM-IDLE mode. Context in the network includes information to enable fast transition to the LTE_ACTIVE state 650. For example, the context information may include NAS security key information. Allocated WTRU IDs may include the IMSI, a GUTI, at least one unique TA ID, or one or more IP addresses, (i.e., the WTRU 410 may be in EMM-REGISTERED state). The WTRU's position may be known by the network at the TA level. WTRU Mobility may include cell reselection between non-3GPP access and LTE and DL/UL activity may include the WTRU 410 being configured with a discontinuous reception (DRX) period over the non-3GPP access.

In the LTE_ACTIVE state 650, the RRC is in an RRC_CONNECTED state. Context in the network includes all information necessary for communication. The allocated WTRU ID may include the IMSI, a GUTI, at least one unique TA ID, a unique cell radio network temporary identifier (C-RNTI), or one or more IP addresses. The WTRU's position may be known by the network at the cell level. WTRU Mobility includes handover and the WTRU 410 may be configured with a discontinuous transmission (DTX)/discontinuous reception (DRX) period. Thus the LTE_ACTIVE state represents a WTRU context in the network, (e.g., the WTRU 410 NAS EMM is in the EMM-REGISTERED state), and the availability of a signaling connection with the network, (e.g., the WTRU 410 NAS EMM is in EMM-IDLE mode and/or the WTRU 410 RRC is in the RRC-CONNECTED state).

The Non-3GPP_IDLE state 630 and the non-3GPP_DETACHED state 615 may differ from the normal LTE_Idle and LTE_Detached states 640 and 620, respectively, because the properties of the WTRU 410 in these states may be different. The WTRU 410 may not monitor LTE paging channels in the non-3GPP_Idle state 630 whereas it may monitor paging channels in the LTE_Idle state 640.

The states and functionalities described herein may be incorporated as WTRU functions in different ways, (e.g., as sub-states of existing NAS EMM states, as new EMM states, or as new EMM modes). Also different and new functions may be defined for these states that are consistent with merging two states into one. Different names may be also be utilized for the NAS EMM states which incorporate these functionalities.

Continuing to refer to FIG. 6, a state transition (ST) may be triggered by various causes, which will be described in reference to the state numbers one (1) through fourteen (14) designated by the circled number 1-14 in FIG. 6. Although fourteen causes are depicted in FIG. 6 and described below, it should be noted that other causes may trigger an ST that are not described.

ST 1 may be triggered by a handover to 3GPP from non-3GPP, (e.g., LTE), (possibly with target cell info), power down or radio link failure of the non-3GPP RAT, or an internal trigger in the WTRU 410. In this case, the WTRU 410 begins in the Non-3GPP_IDLE state 630 and proceeds to the LTE_ACTIVE state 650.

ST 2 may be triggered by a network initiated detach, unavailable 3GPP coverage, failure of an NAS procedure, (e.g., such as tracking area update (TAU), authentication, expiration of timers, and the like), or an internal trigger in the WTRU 410 such as the expiry of a timer. The timer may represent the duration for which the WTRU 410 may maintain its registration status and context with the EPC without the availability of an underlying 3GPP layer 2 access before it transitions to a different EMM state. In this case, the WTRU 410 begins in the Non-3GPP_IDLE state 630 and proceeds to the Non-3GPP_DETACHED state 615. Alternatively upon expiration of the timer, the WTRU 410 may move to an EMM-NULL state or some other sub-state of EMM-DEREGISTERED such as the EMM-DEREGISTERED.NO-CELL-AVAILABLE sub-state.

ST 3 may be triggered by a handover to 3GPP, possibly without target cell info, re-selection to a 3GPP cell from a non-3GPP access, or an internal trigger in the WTRU 410, such as a manual trigger to move to LTE. The command to handover to a 3GPP access network such as LTE may be signaled per a non-3GPP access-specific protocol, (e.g. a CDMA2000 message).

ST 4 may be triggered by a switch to 3GPP mode, (e.g., automatic/user selection), without any target 3GPP cell indication or WTRU internal trigger. In this case, the WTRU 410 begins in the Non-3GPP_IDLE state 630 and proceeds to the LTE_DETACHED state 620.

ST 5 may be triggered by completion of an attach, authentication, or service request over a non-3GPP L2 tunnel, or WTRU internal trigger. In this case, the WTRU 410 begins in the Non-3GPP_DETACHED state 615 and proceeds to the Non-3GPP_IDLE state 630.

ST 6 and ST 7 may be triggered by a WTRU internal trigger, (e.g., manual command to use 3GPP access such as LTE). In case ST 6, the WTRU 410 begins in the Non-3GPP_DETACHED state 615 and proceeds to the LTE_ACTIVE state 650. In case ST 7, the WTRU 410 begins in the Non-3GPP_DETACHED state 615 and proceeds to the LTE_IDLE state 640. In case ST 7 the WTRU 410 may perform pre-registration with the 3GPP network over its non-3GPP layer 2 access before moving to the target LTE cell.

ST 8 may be triggered by a switch to 3GPP mode, (e.g., automatic/user selection), or WTRU internal trigger. In this case, the WTRU 410 begins in the Non-3GPP_DETACHED state 615 and proceeds to the LTE_DETACHED state 620.

ST 9 may be triggered by a switch to non-3GPP mode, such as handover, and possibly without an explicit indication to the network or WTRU internal trigger. The indication to handover may be by using LTE RRC signaling and may include an explicit or implicit indication to detach from the 3GPP network upon completing the handover to the target non-3GPP access. In this case, the WTRU 410 begins in the LTE_ACTIVE state 650 and proceeds to the Non-3GPP_DETACHED state 615. Alternatively the WTRU 410 NAS may move to the state EMM-NULL or the EMM-DEREGISTERED.NO-CELL-AVAILABLE sub-state upon handover to the non-3GPP target cell. The WTRU 410 NAS may receive the indication of handover to the non-3GPP access network from the Access Stratum, (e.g., RRC), and/or from the non-3GPP access protocol stack in the WTRU 410.

ST 10 may be triggered by a switch to non-3GPP mode, (e.g., handover to CDMA2000 network), or a WTRU internal trigger. The indication to handover may be signaled by using LTE RRC signaling and may include an explicit or implicit indication to remain attached to the 3GPP network upon completing the handover to target non-3GPP access. In this case, the WTRU 410 begins in the LTE_ACTIVE state 650 and proceeds to the Non-3GPP_IDLE state 630. Alternatively, the WTRU 410 NAS may move to an EMM-REGISTERED.NO-CELL-AVAILABLE sub-state upon handover to a non-3GPP target cell. The WTRU 410 NAS may receive the indication of handover to the non-3GPP network from the Access Stratum (e.g. RRC) and/or from the non-3GPP access protocol stack in the WTRU 410.

ST 11 may be triggered by a switch to non-3GPP mode, (e.g., re-selection or user initiated), or a WTRU internal trigger. In this case, the WTRU 410 begins in the LTE_IDLE state 640 and proceeds to the Non-3GPP_DETACHED state 610. This case may be applicable if the WTRU 410 re-selected to the non-3GPP network with an attempt to detach from the 3GPP network.

ST 12 may be triggered by a re-selection to a non-3GPP cell or WTRU internal trigger. In this case, the WTRU 410 begins in the LTE_IDLE state 640 and proceeds to the Non-3GPP_IDLE state 630. This case may be applicable if the WTRU 410 re-selected to a non-3GPP technology without completing or attempting a detach procedure with the 3GPP EPC network.

ST 13 may be triggered by a switch to a non-3GPP mode (automatic/user selection) or a WTRU internal trigger. In this case, the WTRU 410 begins in the LTE_DETACHED state 620 and proceeds to the Non-3GPP_DETACHED state 610.

ST 14 may be triggered by a WTRU internal trigger. In this case, the WTRU 410 begins in the LTE_DETACHED state 620 and proceeds to the Non-3GPP_IDLE state 610.

Additionally, the WTRU 410 may move into a NULL, (i.e., Power Off), state, (e.g., EMM-NULL—not shown), from any of the depicted states in FIG. 6. The reason for this move may be, among other things, an authentication failure or a timer expiration. The causes for the state transitions (1-14) described above apply in this case as well as additional causes.

Also, the events described for some state transitions may be used in others. The WTRU 410 internal triggers may be messages, signals, parameters, or primitives passed by any part of the WTRU 410. For example, an application, AT command, access stratum (AS), measurements, timers, commands, and the like may be utilized.

A NAS message sent in non-3GPP_DETACHED state 615 or non-3GPP IDLE state 630 may be sent to a session access point interface (SAPI) other than the one between the NAS and AS during normal procedures in 3GPP mode. As an example, it may be sent by the NAS to an interface between the NAS and the non-3GPP access protocol stack in the WTRU 410.

Other functions may also be performed in the various states described in FIG. 6. For example, in the non-3GPP_DETACHED state 615, a 3GPP stack in the WTRU 410 may perform measurements of LTE cells. These measurements may be performed in accordance with the measurement principles and instructions of the non-3GPP RAT stack in the WTRU 410, such as by using measurement information provided by the non-3GPP stack in the WTRU 410. Alternatively, these measurements may be made when the non-3GPP stack in the WTRU 410 does not access the radio, such as during a DTX/DRX measurement gap. The target cells to be measured may be identified to the 3GPP stack by means of a carrier center frequency, physical or broadcast cell-ID, bandwidth and/or PLMN ID.

Other functions that may be performed by the 3GPP stack in the WTRU 410 while the WTRU 410 is in the non-3GPP_DETACHED state 615 include:
Reading the system information block (SIBs) or management information base (MIBs) of target candidate LTE cell, or cells. This may be done to read the cell/eNB ID, associated tracking area code, PLMN ID, and MME ID.
Selecting a candidate or candidate set of target cells.
Selecting a candidate, or candidates using similar principles as PLMN and/or cell selection.
Reporting the candidate or target measurements to the 3GPP network over a non-3GPP tunnel, or to the non-3GPP network by using non-3GPP signaling.
Choosing whether or not to camp on the cell.
Making decisions, (e.g., whether to camp, selecting candidate cells, and the like), based on ongoing service in non-3GPP stack in WTRU 410. Sending NAS signaling using a non-3GPP tunnel, (e.g., attach, service request, or authenticate signaling).
Choosing to send a modified form of NAS/RRC messages over the non-3GPP tunnel. It might send an ATTACH message with certain information elements (lEs) and information coded. If it is sending an ATTACH message over a non-3GPP RAT, the contents of the message may be different.

Also, when in the non-3GPP_DETACHED state, the 3GPP stack in the WTRU 410 may be informed of the candidate or target LTE cell, or cells, by the non-3GPP network. This information may contain at least one of target cell ID, downlink center frequency and bandwidth of target cell. Some context may be retained from or to the previous or next state when entering or leaving the non-3GPP_DETACHED state. Additionally, the functions may reside in the NAS and/or AS of the 3GPP stack in the WTRU 410.

In the non-3GPP Idle state, the following conditions or functions may be associated with the 3GPP stack in the WTRU 410:
It may be authenticated and/or attached to 3GPP network.
The WTRU 410 location may or may not be known by the network at a tracking area level.
The WTRU 410 may listen to pages over a 3GPP network.
The WTRU 410 may be paged over the non-3GPP tunnel.
The WTRU 410 may have a DRX period in the non-3GPP access network to listen for the LTE paging channel configured by the 3GPP network or some other entity.
The WTRU 410 may perform measurements to select better candidate 3GPP cells. These measurements may be performed in accordance to the measurement principles of the non-3GPP RAT stack in the WTRU 410. These measurements may also be made when the non-3GPP stack in the WTRU 410 does not access the radio, such as during a DRX, DTX, or measurement gap of the non-3GPP access network. The target cells to be measured may be identified to the 3GPP stack by way of a carrier center frequency and/or physical cell-ID and/or broadcasted cell-ID and/or PLMN ID.
The 3GPP stack in the WTRU 410 may read the SIB/MIB of a cell. This may be done to read the cell/eNB ID, associated tracking area code, PLMN ID, and/or mobility management entity (MME) ID.
The WTRU 410 may perform tracking area updates over non-3GPP tunnel, and may be assigned tracking areas by the 3GPP network over the non-3GPP L2 access tunnel.
The WTRU 410 may have at least one or more Evolved Packet System (EPS) bearer contexts, depending on the WTRU IP stack architecture.

When entering or leaving the 3GPP Idle state, some context information may be retained from the previous state or sent to the next state. In the cases described above the functionalities may reside in the NAS and/or AS of the 3GPP stack in the WTRU 410. The WTRU 410 may initiate tunnel establishment based on, for example, degrading radio conditions.

In another example, the WTRU 410 could re-select to an LTE cell from a non-3GPP cell. By performing tunnel establishment, pre-authentication, and registration before re-selecting, the initial access procedure in the target LTE may be expedited. Steps may be taken to ensure that the cell re-selected by non-3GPP RAT is given priority when the WTRU 410 transitions to LTE Mode. The prioritization may include that when the WTRU 410 moves to LTE mode from non-3GPP access instead of initiating a full PLMN and cell search, the WTRU 410 may try to camp on the cell re-selected to by the non-3GPP RAT.

A WTRU internal trigger may trigger any of the state transitions. The WTRU trigger may include a state transition within the non-3GPP stack, procedure in the non-3GPP protocol stack, timers, commands or primitives.

In order to accommodate the behavior of the 3GPP stack when the non-3GPP stack in the WTRU 410 is active, the RRC state machine, which currently consists of the states NULL, Idle, and Connected, may be modified. One way of modifying it may be by adding additional states, such as RRC_NULL_non-3GPP and RRC_Idle_non-3GPP. The functionalities of these states are described below and may be incorporated into existing RRC states as sub-states, distributed over the NAS or AS, or be merged into a single state.

In the RRC_NULL_non-3GPP state, the 3GPP stack in the WTRU 410 may scan and measure available LTE cells, and additionally may attempt to ensure that there are no higher order PLMNs available by performing periodic background scans of higher priority PLMNs using LTE technology using gaps in the transmission/reception of the non-3GPP access. The 3GPP stack may be instructed by the non-3GPP stack to detect and measure specific cells identified by at least one of physical cell identification, a broadcast level cell identification, a centre frequency and bandwidth, and report the results to the non-3GPP stack.

The 3GPP stack in the WTRU 410 may report the measured parameters, read the SIBs/MIBs of the target cells, identified by at least one of physical cell identification, a broadcast level cell identification, a centre frequency and bandwidth, and report or store the read parameters. In addition, the 3GPP stack in the WTRU 410 may report the detected tracking areas to the NAS, and may decide the target candidate cell.

In the RRC_Idle_non-3GPP state, the WTRU 410 may have a candidate or target LTE cell to monitor that may be selected by the WTRU 410 or the network. The WTRU 410 may seek better LTE cells that are available, report other measured cells periodically, using, for example, a non-3GPP tunnel, or it may make its own decisions regarding a best cell.

In the RRC_Idle state, the WTRU 410 may monitor paging channels at intervals scheduled by the network. Since the non-3GPP stack in the WTRU 410 has access to a single radio in the RRC_Idle_non-3GPP state, the WTRU 410 may monitor paging channels when the non-3GPP stack in the WTRU 410 does not have radio access. The WTRU 410 may receive a page over the non-3GPP tunnel, while it may not receive any page or monitor paging channel. The WTRU 410 may simulate the monitoring of paging channels to the NAS. In addition, the transitions between the various proposed and existing RRC states may be caused by the same, or similar, causes described above in FIG. 6.

The non-3GPP stack in the WTRU 410 may be presented as a 3GPP stack to the NAS or AS. This may be similar to the Generic Access Network (GAN) approach. Unlike GAN however, the non-3GPP RAT may be presented as any 3GPP technology. For example, the non-3GPP RAT may be presented as a “limited access technology” to the NAS or AS, where the NAS or AS may perform a limited set of operations. A logical layer may abstract the limited access technology from the 3GPP NAS or AS.

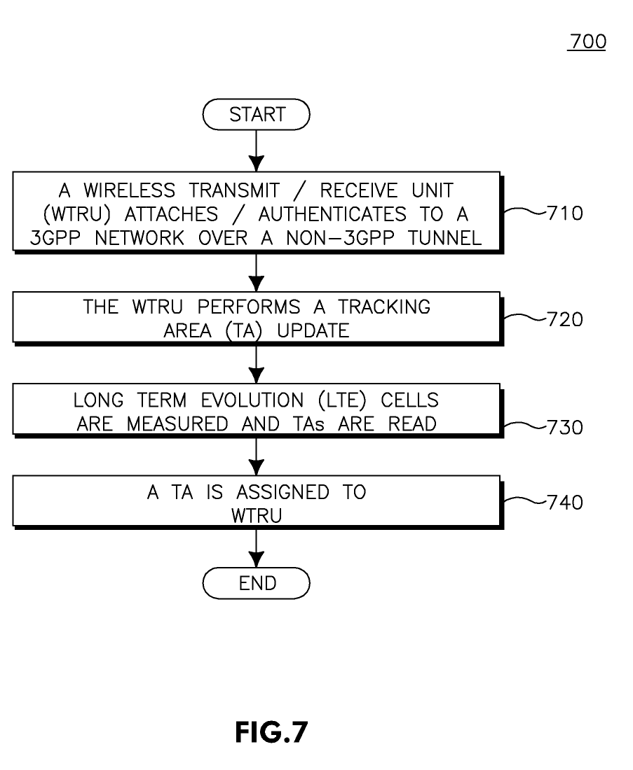

FIG. 7 is a flow diagram of a method 700 of handling tracking updates. One purpose of tracking areas is to page the WTRU 410 in Idle mode. However, if the WTRU 410 is LTE attached and authenticated over a non-3GPP tunnel, then it may not be necessary to assign a tracking area (TA) to the WTRU 410, as the WTRU may not monitor a LTE paging channel. In other words if the network sends an ATTACH ACCEPT NAS message to a WTRU attempting to attach over a non-3GPP L2 access tunnel, it may not include a Tracking Area Identity (TAI) list and/or a periodic tracking area update timer. Furthermore, the SIBs containing the TA information may not be read by the WTRU 410 during the measurement and handover preparation phase. Accordingly, method 700 of handling tracking updates may be employed to overcome these issues. The steps of method 700 may also be applied to a WCDMA or GSM Edge Radio Access Network (GERAN) WTRU using location area or routing area concepts.

In step 710, the WTRU 410 attaches/authenticates to a 3GPP network over a non-3GPP tunnel. During this time, the WTRU 410 may choose to not indicate any TAs, (e.g., in an attach/service request). Also, the WTRU 410 may choose to include Cell ID(s)/eNB ID(s) of detected or measured cells as part of its ATTACH REQUEST procedure. It may also be the case that no TAs may be assigned to the WTRU 410 as part of the ATTACH ACCEPT message or service request procedure.

Upon handoff to LTE, the WTRU 410 may perform a TA update (step 720) even if it received a Tracking Area as part of it pre-registration procedures with the EPC network over the non-3GPP access network. During measurement of LTE cells by the WTRU 410 (step 730), the TAs with which the cells are associated may be read and stored by the WTRU 410 and provided to the NAS. The TA associated with the LTE cell may be reported as part of a non-3GPP RAT signaling or measurement report or as part of the messages sent over the non-3GPP tunnel.

The MME may use the measured or candidate LTE handover cell, provided by a non-3GPP network or by the WTRU 410 across a tunnel, and its own geographical knowledge of which cell is in which tracking area to assign TAs to the WTRU 410. It may do so without the WTRU having requested a tracking area update (TAU). Additionally, a mapping between TAs may be maintained along with an equivalent of TAs in non-3GPP networks. By knowing the TA equivalent of the non-3GPP RAT, the network knows the TA that the 3GPP RAT WTRU 410 is in.

The network may allocate, then to the WTRU 410, one or more TAs for use when it is in a non-3GPP network (step 740). This can allow the MME to re-direct any incoming calls to the appropriate non-3GPP network.

The 3GPP and non-3GPP networks may be synchronized so that the WTRU 410 is paged over the 3GPP network at a time when the non-3GPP stack in the WTRU 410 is not using a radio. The 3GPP stack in the WTRU 410 listens to paging cycles during these intervals. To this end, the 3GPP stack in the WTRU 410 may request, based on an internal clock, knowledge of the non-3GPP stack silent periods and knowledge of the timing of the LTE cells. In this way, it can be configured with appropriate DRX periods in 3GPP Idle mode. This allows the WTRU 410 to tune away from the non-3GPP RAT and listen to pages over the LTE cell. The non-3GPP network may resolve the MME ID based on WTRU detection.

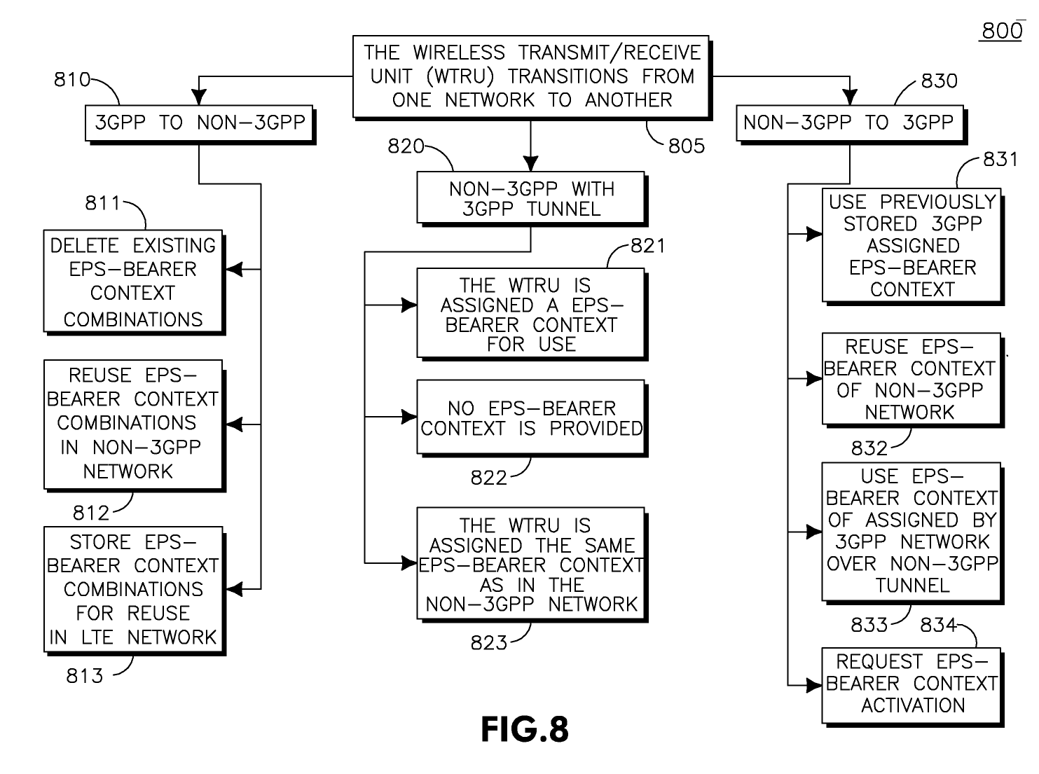

The “always-on” design of the LTE PS domain may mean that the WTRU 410 always has a default EPS bearer context assigned to it, even when in Idle mode. When the WTRU 410 is using a non-3GPP RAT, it is possible that the WTRU 410 has an IP address from the non-3GPP stack. Accordingly, it may be beneficial to manage a EPS context in the 3GPP stack. FIG. 8 is a flow diagram of a method 800 of handling EPS bearer context transfers

In step 805, the WTRU 410 transitions from one network to another. For example, the WTRU 410 may transition from a 3GPP to a non-3GPP network (step 810). Alternatively, the WTRU 410 may be in a non-3GPP network and include a non-3GPP tunnel that carries the 3GPP NAS signaling (step 820). Also, the WTRU 410 may transition from a non-3GPP network to a 3GPP network (step 830).

When the WTRU 410 transitions from a 3GPP network to a non-3GPP network, such as in step 810, it may perform a variety of functions. For example, the WTRU 410 may delete any combination of existing EPS contexts (step 811). The WTRU 410 may also re-use any combination of existing EPS contexts in the non-3GPP network (step 812), and/or store any combination of existing EPS contexts for re-use when the WTRU 410 returns to the LTE network (step 813).

When the WTRU 410 is in non-3GPP network and has a non-3GPP tunnel carrying 3GPP NAS signaling, as in step 820, the 3GPP network may assign the WTRU 410 an EPS bearer context for use when handoff to the 3GPP LTE network is performed (step 821). Alternatively, the 3GPP network may not provide any EPS bearer contexts (step 822), or assign the WTRU 410 the same IP address in the EPS bearer context as that being used in the non-3GPP network (step 823).

When the WTRU 410 transitions to a 3GPP network from a non-3GPP network (step 830), the WTRU 410 may use any previously stored 3GPP assigned EPS bearer Context (step 831). Also, the WTRU 410 may re-use the EPS bearer Context equivalent or IP address of the non-3GPP network in the 3GPP network (step 832). The WTRU 410 may use any EPS bearer context assigned by the 3GPP network over the non-3GPP tunnel (step 833), or the WTRU 410 may request the activation of an EPS bearer Context (step 834).

In all of the transitions described above in FIG. 8, timers associated with a EPS bearer context may be modified to allow for longer lifetime of EPS bearers contexts over the non-3GPP tunnel.

Additional functions may be performed when the WTRU 410 transitions to an LTE cell from a non-3GPP cell. For example, the WTRU 410 may perform a tracking area update and obtain a new EPS bearer context in one step. This may be performed in the initial NAS/RRC signaling over the target LTE cell. This round trip signaling may also include information necessary for beginning RRC and U-plane security as well as radio bearer configurations.

The radio bearers may be configured and resources reserved during handover preparation by the target eNB 420 and the configuration set may have an ID that was provided to the WTRU 410 during preparation. During the round trip, the WTRU 410 may provide a radio bearer configuration set ID that would allow the target to retrieve the configuration reserved and indicate it to the WTRU 410.

Alternatively the target eNB 420 could retrieve and signal the radio bearers configured for a particular WTRU 410 using the cell radio network temporary identifier (C-RNTI) that the WTRU 410 is using for access since the C-RNTI is allocated by the target eNB 420 to the WTRU 410 during handover preparation.

Since the WTRU 410 is capable of performing the attach and authentication procedure in LTE before it transitions to the LTE network, when the WTRU 410 sends the first message on the random access channel (RACH), the LTE network may directly identify the WTRU 410 and send its response, thereby sending a temporary C-RNTI. When the WTRU 410 sends the RRC connection request, the WTRU 410 may then embed its tracking area update request and request for activation of the security procedure.

The embedding of an NAS level message within an RRC message may be performed in a conventional manner. A network, in its RRC connection setup, could activate the security procedure and complete the tracking area. The WTRU 410 may also embed the service request with the RRC connection request, but this could be decided based on size restrictions of the message.

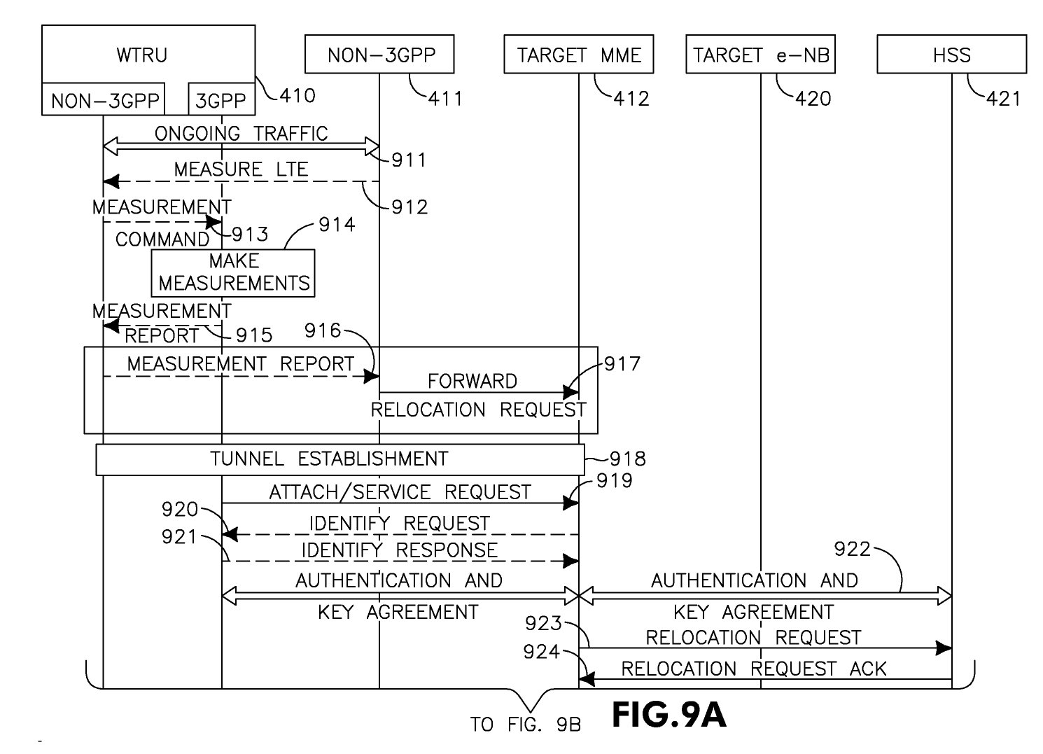

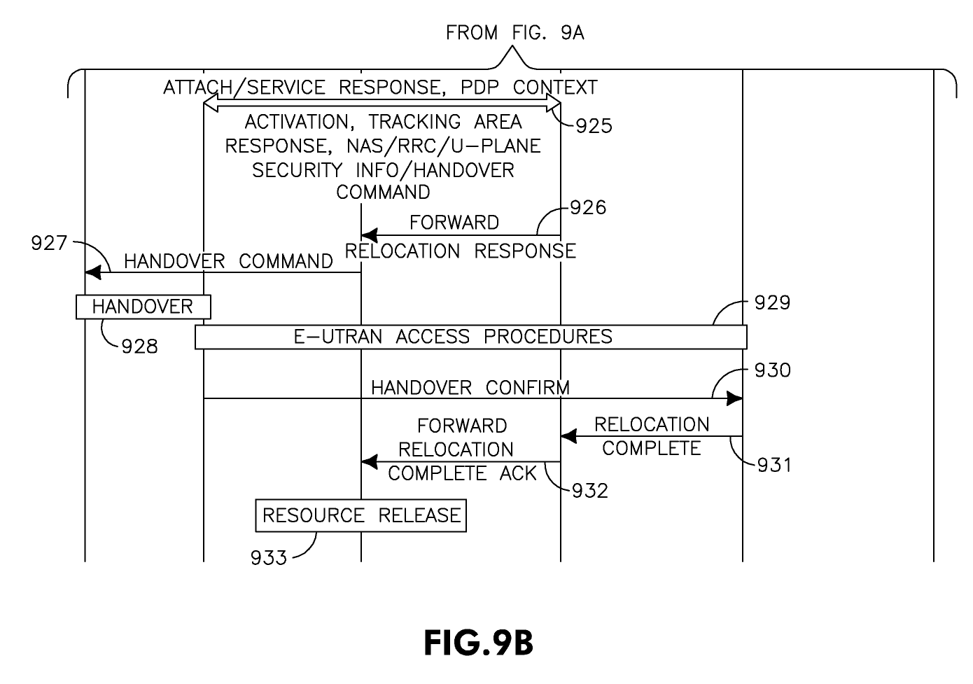

FIGS. 9A-9B are an example signal diagram 900 for a non-3GPP to 3GPP handover. As shown in FIGS. 9A-9B, a WTRU 410, a non-3GPP network 411, a target mobility management entity (MME), a target eNB 420, and a home subscriber server (HSS) 421 are in various states of communication with one another. The WTRU 410 in FIGS. 9A-9B is shown as having a 3GPP access protocol stack and a non-3GPP access protocol stack.

Ongoing traffic (911) is shown as occurring between the non-3GPP access protocol stack of the WTRU 410 and the non-3GPP network 411. A measure LTE message (912) is sent from the non-3GPP network 411 to the non-3GPP access protocol stack of the WTRU 410, which sends the details of the measurement command (913) to the 3GPP access protocol stack of the WTRU 410.

The 3GPP access protocol stack then makes measurements (914) and forwards a measurement report (915) to the non-3GPP access protocol stack. A handover decision is then made starting with the measurement report signal (916) being forwarded by the non-3GPP entity to the non-3GPP network 411. The non-3GPP network 411 then sends a forward relocation request message (917) to the target MME 412. The relocation request message (917), or an equivalent message, the non-3GPP network may also provide the MME with information related to services involved in a handover. For example, Quality of Service (QoS) parameters and/or IP address information may be included in message 917. It may also be the case that the relocation request message (917) may be an indication of a handover in order to establish a tunnel and resources.

In step 918, a tunnel establishment occurs between the WTRU 410, the non-3GPP network 411 and the target MME 412. Tunnel establishment may be initiated by the target MME 412, the non-3GPP network 411 or the WTRU 410. For example, the tunnel establishment may be triggered by the non-3GPP network sending a message consistent with non-3GPP protocol to the non-3GPP access protocol stack in the WTRU 410 that commands the WTRU to handover to 3GPP LTE. This may be used as a trigger for tunnel establishment. Once the tunnel is established, additional steps and signals may be performed and sent that involve the WTRU 410, target eNB 420, non-3GPP network 411, target MME 412 and/or the HSS 421, as necessary. These steps may be performed by signaling over the tunnel or over parts of the tunnel. Radio bearer configurations and their mapping to EPS bearers and UL/DL traffic flow template (TFT) allocation may be sent over the non-3GPP network signaling. In addition, RRC signaling and information may be passed in the tunnel. It may be passed as NAS signaling, and may be passed transparently by the NAS layer in the WTRU 410 to the RRC layer.

In one example, the triggering of the tunnel establishment may be initiated by the WTRU 410 by defining an event dedicated to triggering a tunnel establishment. The actual handover command may be sent later using the forward relocation command and reported to the target eNB 420 or target MME 412 by the WTRU 410 through a different handover event.

Once the tunnel is established, an attach/service request message (919) is sent from the 3GPP access protocol stack of the WTRU 410 to the target MME 412. The target MME 412 replies with an identify request message (920), and the 3GPP access protocol stack responds to the request with an identify response message (921). Authentication and key agreement (step 922) then occurs between the 3GPP access protocol stack in the WTRU 410 and the target MME 912 and the target MME 912 and the HSS 421. At this point, the target MME 912 sends a relocation request message (923) to the HSS 421, which responds with a relocation request acknowledgment (ACK) signal (924).

Any of attach/service response, EPS bearer context activation, TA response, NAS/RRC/U-Plane security information, and handover commands are exchanged between the 3GPP access protocol stack and the target MME 412 (step 925) over the non-3GPP tunnel. The target MME 412 sends a forward relocation response message (926) to the non-3GPP network 411. The forward relocation response message may be modified such that it can trigger just a tunnel establishment or a message may be defined that is specific for tunnel establishment. The non-3GPP network 411 then may send a handover command (927) to the non-3GPP access protocol stack in the WTRU 410. Handover then occurs from the non-3GPP access protocol stack to the 3GPP access protocol stack in the WTRU 410 (step 928) and E-UTRAN access procedures occur between the 3GPP entity and the target eNB 420 (step 929).

The 3GPP access protocol stack sends a handover confirmation message (930) to the eNB 420, and the eNB 420 sends a relocation complete message (931) to the target MME 412. The target MME 412 forwards the relocation complete message (932) to the non-3GPP network 411, which subsequently releases resources (step 933).

Accordingly, the following steps may occur by signaling over the tunnel or any part of it:
a. Network registration and/or Attach and/or identification and/or authentication and key agreement (AKA);
b. Exchange of capability information;
c. Service request;
d. Tracking area procedures;
e. EPS bearer establishment and radio bearer setup;
f. S1 tunnel establishment and identification of tunnel endpoints;
g. Allocation of IP address;
h. Allocation of UL/DL TFT filters;
i. Mappings between EPS bearers, radio bearers, S1 tunnel endpoint identifiers (TEIDs), UL/DL TFTs and IP addresses and their equivalents in the non-3GPP access;
j. Security procedures (e.g. NAS/RRC/U-plane security algorithm selection);
k. C-RNTI and/or random number allocation;
l. Radio information of target eNB required for cell access, for example, RACH preamble, CQI parameters and RACH scheduling information; and
m. Handover command.

In particular, the bearer establishment and associated steps, such as IP address allocation and UL/DL TFT filter allocation, could be initiated by the 3GPP stack in the WTRU 410 over the tunnel based on ongoing traffic over the non-3GPP RAT or could be initiated by the target MME 412 over the tunnel based on the QoS parameters it receives from the non-3GPP RAT.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A method for handling mobility between a non-third generation partnership project (3GPP) radio access technology (RAT) and a 3GPP RAT, comprising:
utilizing services provided by the non-3GPP RAT;
determining the need to utilize services provided by the 3GPP RAT;
entering a 3GPP non-access stratum (NAS) state;
tunneling 3GPP messages to the 3GPP EPC network over the non-3GPP access RAT;
transitioning from the non-3GPP RAT to the 3GPP RAT;
triggering a 3GPP NAS state transition; and
transitioning to a second 3GPP NAS state.

2. The method of claim 1 wherein the 3GPP NAS state includes a non-3GPP_DETACHED state.

3. The method of claim 2, further comprising performing measurements of long term evolution (LTE) cells during gaps configured in non-3GPP access signaling.

4. The method of claim 3 wherein the measurements of the LTE cells are made during a period when there is no access to a non-3GPP radio.

5. The method of claim 4 wherein the period for which there is no access to the non-3GPP radio includes a discontinuous transmission (DTX) period.

6. The method of claim 4 wherein a period wherein there is no access to a non-3GPP radio includes a discontinuous reception (DRX) period.

7. The method of claim 3, further comprising selecting a candidate LTE cell to handover to.

8. The method of claim 2, further comprising receiving an indication of a candidate long term evolution (LTE) cell.

9. The method of claim 1 wherein the 3GPP NAS state includes a non-3GPP_IDLE state.

10. The method of claim 9, further comprising authenticating to a 3GPP evolved packet core (EPC) network.

11. The method of claim 10, further comprising attaching to the 3GPP EPC network.

12. The method of claim 9, further comprising activating an Evolved Packet System (EPS) bearer context.

13. The method of claim 9, further comprising performing tracking area (TA) updates over the non-3GPP tunnel.

14. The method of claim 9, further comprising entering a non-3GPP_IDLE state upon successful attachment with the 3GPP EPC network over the non-3GPP RAT.

15. The method of claim 9, further comprising entering a non-3GPP_IDLE state after successful handover from the 3GPP EPC network to the non-3GPP RAT.

16. The method of claim 15 wherein attachment to the 3GPP EPC network is maintained.

17. The method of claim 1, further comprising entering a 3GPP LTE radio resource control (RRC) state when using the services of the non-3GPP (RAT).

18. The method of claim 17 wherein the RRC state includes an RRC_NULL_non-3GPP state.

19. The method of claim 18, further comprising scanning and measuring long term evolution (LTE) cells.

20. The method of claim 19, further comprising reporting the measurement results.

21. The method of claim 19, further comprising determining a candidate cell.

22. The method of claim 17 wherein the RRC state includes an RRC_Idle_non-3GPP state.

23. The method of claim 22, further comprising monitoring paging channel when not transmitting or receiving on the non-3GPP radio access network.

24. A method for handling mobility between a non-third generation partnership project (3GPP) network to a 3GPP evolved packet core (EPC) network, comprising:
performing an attach procedure with the 3GPP EPC network over a non-3GPP tunnel;
authenticating to the 3GPP EPC network over a non-3GPP tunnel; and
managing tracking areas (TAs).

25. The method of claim 24, further comprising receiving an ATTACH ACCEPT message, wherein the ATTACH ACCEPT message does not include an indication of an assigned TA.

26. The method of claim 24 wherein managing TAs includes performing a TA update.

27. The method of claim 24 wherein managing TAs includes reporting a TA associated with a long term evolution (LTE) cell.

28. The method of claim 24, further comprising synchronizing the non-3GPP network and the 3GPP network.

29. The method of claim 24, further comprising receiving a TA assignment.

30. A method for handling mobility between a non-third generation partnership project (3GPP) network and a 3GPP network, comprising:
executing a transition from a first network to a second network; and
performing an operation to ensure availability of a parameter in the second network upon executing the transition.

31. The method of claim 30 wherein a parameter includes any one of the following: an internet protocol (IP) address and a quality of service (QoS) parameter.

32. The method of claim 31 wherein the QoS parameter includes any of the following: a 3GPP uplink/downlink (UL/DL) traffic flow template and a radio bearer ID.

33. The method of claim 30 wherein the transition includes a handover.

34. The method of claim 30 wherein the transition includes a cell re-selection.

35. The method of claim 30 wherein the first network is the 3GPP network and the second network is the non-3GPP network.

36. The method of claim 35, further comprising deleting an existing 3GPP assigned IP address and the QoS parameters of that IP address upon executing the transition.

37. The method of claim 36, further comprising re-using a 3GPP assigned IP address in the non-3GPP network.

38. The method of claim 36, further comprising storing a 3GPP assigned IP address and the QoS parameters of that IP address combination.

39. The method of claim 35 wherein the first network is the non-3GPP network and the second network is the 3GPP network.

40. The method of claim 39, further comprising using a previously stored 3GPP assigned IP address and the QoS parameters of that IP address combination upon executing the transition to the 3GPP network.

41. The method of claim 39, further comprising re-using a non-3GPP assigned IP address in the 3GPP network.

42. The method of claim 39, further comprising requesting an evolved packet system (EPS) bearer context activation over the non-3GPP access tunnel prior to performing handover or re-selection to the 3GPP network.

43. The method of claim 42 wherein the EPS bearer activation includes information relating to an IP address and QoS parameters of the IP address.

44. A wireless transmit/receive unit (WTRU) configured to access 3GPP long term evolution (LTE) and non-3GPP radio access technologies (RATs), comprising:
a receiver;
a transmitter; and
a processor in communication with the receiver and the transmitter, the processor configured to enter a third generation partnership project (3GPP) non-access stratum (NAS) state when the receiver and transmitter are operating on a non-3GPP radio access technology (RAT), wherein the NAS state is configured to tunnel 3GPP NAS signaling to a 3GPP network over the non-3GPP RAT, trigger a state transition, and transition to a second NAS state.

45. The WTRU of claim 44 wherein the processor is further configured to perform measurements of long term evolution (LTE) cells during gaps configured in the transmission and reception of non-3GPP access signaling.

46. The WTRU of claim 44 wherein the processor is further configured to perform mutual authentication of an 3GPP evolved packet core (EPC) network using 3GPP NAS signaling transmitted over the non-3GPP access network.

47. The WTRU of claim 44 wherein the processor is further configured to attach to the 3GPP EPC network using 3GPP NAS signaling transmitted over the non-3GPP access network.

48. The WTRU of claim 44 wherein the processor is further configured to activate an Evolved Packet System (EPS) bearer context via 3GPP NAS signaling transmitted over the non-3GPP access network.

49. The WTRU of claim 44 wherein the processor is further configured to perform tracking area (TA) updates via 3GPP NAS signaling transmitted over the non-3GPP access network.

50. The WTRU of claim 44 wherein the processor is further configured to enter a non-3GPP_DETACHED state or a non-3GPP_IDLE state.

51. The WTRU of claim 50 wherein the non-3GPP_IDLE state includes an EPS mobility management (EMM) context.

52. The WTRU of claim 51 wherein the EMM context includes a successful attachment to the 3GPP EPC network.

53. The WTRU of claim 52 wherein the EMM context includes any one of the following: a Globally Unique Temporary Identity (GUTI), at least one tracking area (TA) ID, at least one EPS bearer context, and a security key and algorithm for NAS signaling ciphering and protection.

54. The WTRU of claim 44 wherein the processor is further configured to enter an RRC_NULL_non-3GPP state or an RRC_Idle_non-3GPP state.

55. A wireless transmit/receive unit (WTRU), comprising:
a receiver;
a transmitter; and
a processor in communication with the receiver and the transmitter, the processor configured to utilize services provided by a non-3GPP radio access technology (RAT), determine a need to utilize services provided by a 3GPP RAT, enter a 3GPP non-access stratum (NAS) state, tunnel 3GPP messages to the 3GPP EPC network over the non-3GPP access RAT, transition from the non-3GPP RAT to the 3GPP RAT, trigger a 3GPP NAS state transition, and transition to a second 3GPP NAS state.
